(19) United States
(12) Patent Application Publication
(10) Pub. No.: US 2024/0169654 A1
(43) Pub. Date: May 23, 2024

(54) INFORMATION PROCESSING APPARATUS, INFORMATION PROCESSING METHOD, AND INFORMATION PROCESSING PROGRAM

(71) Applicant: Sony Group Corporation, Tokyo (JP)

(72) Inventors: Daisuke IRIE, Tokyo (JP); Noriaki TAKAHASHI, Tokyo (JP); Koji NISHIDA, Tokyo (JP)

(73) Assignee: Sony Group Corporation, Tokyo (JP)

(21) Appl. No.: 18/279,330

(22) PCT Filed: Feb. 15, 2022
(86) PCT No.: PCT/JP2022/005876

§ 371 Date: Aug. 29, 2023

(30) Foreign Application Priority Data
Mar. 24, 2021 (JP) 2021-050060

(51) Int. Cl. G06T 15/06; G06T 13/20; G06T 15/00

(52) U.S. Cl. CPC G06T 15/06; G06T 13/20; G06T 15/005; G06T 2210/36; G06T 2215/12

(57) ABSTRACT

There is provided an information processing apparatus to create a rendered video by a ray tracing method at higher speed. The information processing apparatus includes: a renderer that renders model data by a ray tracing method and creates a ray traced video, and renders the model data by a method different from the ray tracing method and creates an additional video; and a video synthesis unit that synthesizes the additional video and the ray traced video and creates a synthesized video.

### TECHNICAL FIELD

The present disclosure relates to an information processing apparatus, an information processing method, and an information processing program, which create a rendered video by a ray tracing method.

### BACKGROUND ART

In rendering, ray tracing methods based on ray simulation (ray tracing and path tracing methods) are superior to other rendering methods (non-ray tracing methods such as rasterization and a Z-buffer method) in representing reflection, transmission, and the like of light, and capable of rendering more realistic images. The ray tracing methods are used in various fields (Patent Literature 1 and Patent Literature 2).

Patent Literature 1 discloses an example of rendering of an operation panel on a displayed map in car navigation GUIs. In Patent Literature 1, a partial region is rendered by a ray tracing method, and the other regions by a method different from the ray tracing method. Specifically, a GUI such as a button of the car navigation is displayed in a transmissive manner by ray tracing.

In Patent Literature 2, ray tracing is used in an ultrasonic diagnostic apparatus. In a general technique, a two-dimensional ultrasonic image created from a three-dimensional ultrasonic image by a volume-rendering method is used to confirm an open-close state of a heart valve, but there is a possibility that the visibility is lowered when the valve is not opened very well. In this regard, in Patent Literature 2, using ray tracing together, it is found that the heart valve is opened from the leakage of light, which achieve an improvement in visibility of an open-close state of a heart valve in an ultrasonic image.

### CITATION LIST

### Patent Literature

Patent Literature 1: Japanese Patent Application Laid-open No. 2003-187264
Patent Literature 2: Japanese Unexamined Patent Application Publication No. 2010-188118

### Non-Patent Literature

Non-Patent Literature 1: “Intel® Open Image Denoise”, [online], [retrieved on Feb. 24, 2021], on the Internet <URL: https://www.openimagedenoise.org/index.html>

### DISCLOSURE OF INVENTION

### Technical Problem

Since the ray tracing method needs simulation of thousands to tens of thousands of rays per pixel of a rendered video, the rendering by the ray tracing method needs a very long processing time. In fact, a standby time for rendering is recognized as a major pain point in the scene of movie production.

In this regard, in Non-Patent Literature 1, a high-noise video rendered at high speed, an Albedo component, and a normal map are synthesized by using a DNN by a ray tracing method set at low SPP (e.g., 16 SPP).

In view of the circumstances as described above, it is an object of the present disclosure to create a rendered video by a ray tracing method at higher speed.

### Solution to Problem

An information processing apparatus according to one embodiment of the present disclosure includes: a renderer that renders model data by a ray tracing method and creates a ray traced video, and renders the model data by a method different from the ray tracing method and creates an additional video; and a video synthesis unit that synthesizes the additional video and the ray traced video and creates a synthesized video.

According to this embodiment, the information processing apparatus creates a ray traced video capable of light source component representations or the like at low image quality and at high speed by the ray tracing method. At the same time, the information processing apparatus creates a video incapable of light source component representations or the like but having high image quality (referred to as additional video) at high speed by the non-ray tracing method. The information processing apparatus synthetizes the ray traced video, which has low image quality but is capable of light source component representations or the like, and the additional video, which is incapable of light source component representations or the like but has high image quality. This makes it possible for the information processing apparatus to create a synthesized video, which takes advantage of the merits of the ray traced video and the additional video and compensates for the respective demerits thereof, at high speed.

The renderer may render the model data for every N frames by the ray tracing method, temporally thin out the model data, and create the ray traced video.

The information processing apparatus may further include a motion vector calculation unit that calculates a motion vector from the N frame to a thinned-out frame on the basis of an additional video of the N frame and an additional video of the thinned-out frame, the thinned-out frame being a frame for which a ray traced video is not created.

The video synthesis unit may synthesize the additional video of the thinned-out frame and a corrected ray traced video created by correcting the ray traced video of the N frame on the basis of the motion vector, and may create a synthesized video of the thinned-out frame.

The information processing apparatus of this embodiment temporally thins out the model data to create a ray traced video. Since the number of times of rendering by the non-ray tracing method is reduced, it is possible to take more time for each rendering accordingly and to create a ray traced video at relatively high SPP. Further, as the ray traced video used for the thinned-out frame, a ray traced video, which is corrected on the basis of the motion vector calculated from a plurality of additional videos having been rendered, is used. This makes it possible to create a temporally smooth synthesized video without creating ray traced videos of all frames. This makes it possible to achieve both of high speed and higher image quality.

The information processing apparatus may further include a pre-signal processing unit that creates the corrected ray traced video.

The video synthesis unit may create the corrected ray traced video.

The pre-signal processing unit may correct the ray traced video of the N frame on the basis of the motion vector, to create a corrected ray traced video. In contrast to this, the video synthesis unit may correct the ray traced video of the N frame on the basis of the motion vector when a synthesized video is created, to create a corrected ray traced video.

The information processing apparatus may further include a representation region setting unit that sets a representation region unique to the ray tracing method of the model data.

The renderer may render the representation region of the model data by the ray tracing method and create the ray traced video.

The video synthesis unit may synthesize the additional video and the ray traced video of the representation region and create a synthesized video.

The information processing apparatus of this embodiment limits a rendering target to a representation region unique to the ray tracing method of the model data (in other words, spatially thins out a region to be rendered) to create a ray traced video of only the representation region unique to the ray tracing method. Since the region to be rendered by the ray tracing method is reduced, it is possible to take more time for rendering the representation region accordingly and to create a ray traced video of the representation region at high SPP. This makes it possible to achieve both of high speed and higher image quality.

The renderer may create a mask video for masking the representation region on the basis of a material setting of the model data, and the representation region setting unit may set the representation region specified by the mask video.

The renderer may pre-render the model data by a ray tracing method of lower samples per pixel (SPP) and/or lower resolution than that of the ray tracing method and create a pre-rendered video, and may create a mask video for masking the representation region on the basis of an internal component of the pre-rendered video.

The representation region setting unit may set the representation region specified by the mask video.

The renderer may pre-render the model data by a ray tracing method of lower samples per pixel (SPP) and/or lower resolution than that of the ray tracing method and create a pre-rendered video.

The information processing apparatus may further include a discriminator that discriminates the representation region from the pre-rendered video created by the renderer.

The representation region setting unit may set the representation region predicted from the pre-rendered video.

In the method in which the renderer creates a mask video for masking the representation region, the renderer creates a mask video for masking the representation region according to the system rules of the renderer. Meanwhile, if processing is performed as an external application programming interface (API), it may be impossible to operate the inside of the renderer. In this regard, if a discriminator outside of the renderer specifies the representation region, the processing can be executed as the external API.

The representation region setting unit may set a rendering parameter used when the representation region is rendered by the ray tracing method.

The renderer may render the representation region of the model data by the ray tracing method on the basis of the rendering parameter and create the ray traced video.

The representation region setting unit may set the rendering parameter on the basis of a ratio of the representation region to an entire region of the ray traced video.

This makes it possible to render a ray traced video at the highest image quality in a suitable speed range on the basis of the ratio of the representation region.

The renderer may render the model data by a non-ray tracing method or a ray tracing method of lower samples per pixel (SPP) and/or lower resolution than that of the ray tracing method, as a method different from the ray tracing method, and create the additional video.

A time taken for processing a rendered video by the non-ray tracing method is shorter and faster than in the ray tracing method. The minimum rendering time by the non-ray tracing method is a few milliseconds per frame, and real-time processing is also possible depending on some settings. On the other hand, while the non-ray tracing method can represent at least a subject-specific shape, it fails to represent light source component representations, scattering representations, hair rendering representations, and the like. It is also possible to perform rendering by the ray tracing method at a speed equal to that in the non-ray tracing method if resolution and samples per pixel (SPP) (number of rays) are kept low. However, rendering at low resolution produces an extremely low-resolution ray traced video, and rendering at low SPP produces an extremely high-noise ray traced video, which is impractical. In view of the circumstances as described above, according to this embodiment, the information processing apparatus creates a ray traced video capable of light source component representations or the like at low image quality and at high speed by the ray tracing method. At the same time, the information processing apparatus creates a video incapable of light source component representations or the like but having high image quality at high speed by the non-ray tracing method. The information processing apparatus synthetizes the ray traced video, which has low image quality but is capable of light source component representations or the like, and the additional video, which is incapable of light source component representations or the like but has high image quality. In such a manner, the information processing apparatus creates a synthesized video, which takes advantage of the merits of the ray traced video and the additional video and compensates for the respective demerits thereof, at high speed.

The non-ray tracing method may be a rasterization method, a Z-sorting method, a Z-buffer method, or a scanline method.

The renderer may further create, as the additional video, an internal component including an Albedo component, a normal component, a depth component, a roughness component, a UV map component, an arbitrary output variables (AOVs) component, and/or a shadow map component of the additional video.

The ray tracing method may be ray tracing or path tracing.

The renderer may render the model data by a ray tracing method of SPP less than 16 SPP and create the ray traced video.

According to this embodiment, the information processing apparatus creates, as a video for viewing, a ray traced video capable of light source component representations or the like, and a video incapable of light source component representations or the like but having high image quality (additional video). Since the ray traced video and the additional video are synthesized, there is no problem even if the SPP of the ray traced video is greatly reduced to approximately 1 SPP, because the image quality is ensured by the additional video. This makes it possible to greatly reduce the SPP of the ray traced video to approximately 1 SPP and increase the processing speed.

An information processing method according to one embodiment of the present disclosure includes: rendering model data by a ray tracing method and creating a ray traced video; rendering the model data by a method different from the ray tracing method and creating an additional video; and synthesizing the additional video and the ray traced video and creating a synthesized video.

An information processing program according to one embodiment of the present disclosure causes a processor of an information processing apparatus to operate to: render model data by a ray tracing method and create a ray traced video; render the model data by a method different from the ray tracing method and create an additional video; and synthesize the additional video and the ray traced video and create a synthesized video.

### BRIEF DESCRIPTION OF DRAWINGS

FIG. 1 shows a concept of a first embodiment of the present disclosure.

FIG. 2 shows a configuration of an information processing apparatus.

FIG. 3 shows an operation flow of the information processing apparatus.

FIG. 4 shows a concept of a second embodiment of the present disclosure.

FIG. 5 shows a configuration of the information processing apparatus.

FIG. 6 shows an operation flow of the information processing apparatus.

FIG. 7 shows a configuration of an information processing apparatus of a third embodiment of the present disclosure.

FIG. 8 shows an operation flow of the information processing apparatus.

FIG. 9 shows a concept of a fourth embodiment of the present disclosure.

FIG. 10 shows a configuration of an information processing apparatus.

FIG. 11 shows an operation flow of the information processing apparatus.

FIG. 12 shows a configuration of an information processing apparatus of a fifth embodiment of the present disclosure.

FIG. 13 shows an operation flow of the information processing apparatus.

### MODE(S) FOR CARRYING OUT THE INVENTION

Hereinafter, embodiments of the present disclosure will be described with reference to the drawings.

### I. First Embodiment

### 1. Outline of Information Processing Apparatus

Ray tracing or path tracing is known as rendering by a ray tracing method. The ray tracing method can provide representations such as realistic light reflection, transmission, diffusion, refraction, and shading. Specifically, the ray tracing method can provide light source component representations such as a direct reflected light representation, an indirect reflected light representation, a transmitted light representation, an internally diffused light representation, and a self-luminance representation, scattering representations such as clouds and fog, and hair rendering representations such as hair and fur. On the other hand, the ray tracing method needs a very long processing time. The ray tracing method needs the simulation of thousands to tens of thousands of rays per pixel, which can take several hours per frame.

As rendering by a non-ray tracing method, for example, a rasterization method, a Z-sorting method, a Z-buffer method, and a scanline method are known. A time taken for processing a rendered video by the non-ray tracing method is shorter and faster than in the ray tracing method. The minimum rendering time by the non-ray tracing method is a few milliseconds per frame, and real-time processing is also possible depending on some settings. On the other hand, the non-ray tracing method can represent at least a subject-specific shape, but it fails to represent the light source component representations, the scattering representations, the hair rendering representations, and so on.

The ray tracing method is also capable of performing rendering at a speed equal to that in the non-ray tracing method if resolution or samples per pixel (SPP) (number of rays) are kept low. However, rendering at low resolution produces an extremely low-resolution ray traced video, and rendering at low SPP produces an extremely high-noise ray traced video, which is impractical.

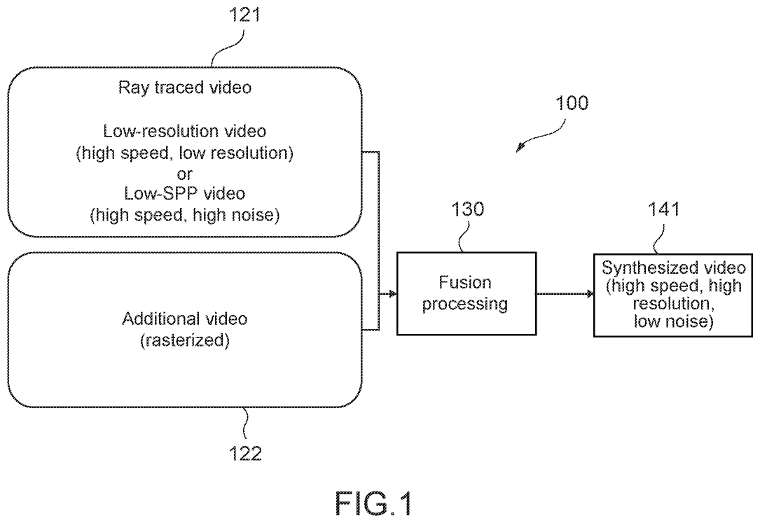

FIG. 1 shows a concept of a first embodiment of the present disclosure.

In view of the circumstances as described above, according to this embodiment, an information processing apparatus 100 creates a ray traced video 121 capable of light source component representations or the like at low image quality and at high speed by the ray tracing method. At the same time, the information processing apparatus 100 creates a video incapable of light source component representations or the like but having high image quality (hereinafter, referred to as additional video 122) at high speed by the non-ray tracing method. The information processing apparatus 100 synthetizes (fuses) the ray traced video 121, which has low image quality but is capable of light source component representations or the like, and the additional video 122, which is incapable of light source component representations or the like but has high image quality, in a video synthesis unit 130. In such a manner, the information processing apparatus 100 creates a synthesized video 141, which takes advantage of the merits of the ray traced video 121 and the additional video 122 and compensates for the respective demerits thereof, at high speed. This is the concept of this embodiment, and the outline thereof is as follows.

The information processing apparatus 100 renders model data by the ray tracing method (ray tracing or path tracing) to create the ray traced video 121. At that time, the information processing apparatus 100 reduces the image quality and performs rendering at high speed. Specifically, the information processing apparatus 100 creates a low-resolution ray traced video 121 at high speed by rendering at low resolution, or creates a high-noise ray traced video 121 at high speed by rendering at low SPP (e.g., 1 SPP). In this embodiment, the “video” means both of a still image and a moving image irrespective of a still image or a moving image.

At the same time, the information processing apparatus 100 creates the additional video 122 by rendering the same model data by a method different from the ray tracing method. The method different from the ray tracing method is typically a non-ray tracing method (rasterization method, Z-sorting method, Z-buffer method, scanline method, or the like). Hereinafter, the non-ray tracing method (particularly, a rasterization method) will be described as an example of the method different from the ray tracing method. For example, if the information processing apparatus 100 performs rendering using normal setting values in the rasterization method, it can render a high-resolution and low-noise video at high speed, though it is incapable of providing light source component representations, scattering representations, hair rendering representations, and the like. Alternatively, as the method different from the ray tracing method, the information processing apparatus 100 may perform rendering by a ray tracing method at lower SPP and/or lower resolution than in the ray tracing method described above to create the additional video 122. The information processing apparatus 100 may further create, as the additional video 122, internal components including an Albedo component, a normal component, a depth component, a roughness component, a UV map component, an arbitrary output variables (AOVs) component, and/or a shadow map component of the additional video 122.

The information processing apparatus 100 then performs synthesis (fusion) processing on the additional video 122 and the ray traced video 121 by a deep neural network (DNN) or a guided filter to create the synthesized video 141. This makes it possible for the information processing apparatus 100 to create a high-resolution and low-noise synthesized video 141, which achieves light source component representations, scattering representations, hair rendering representations, and the like, at high speed by the ray tracing method.

### 2. Configuration of Information Processing Apparatus

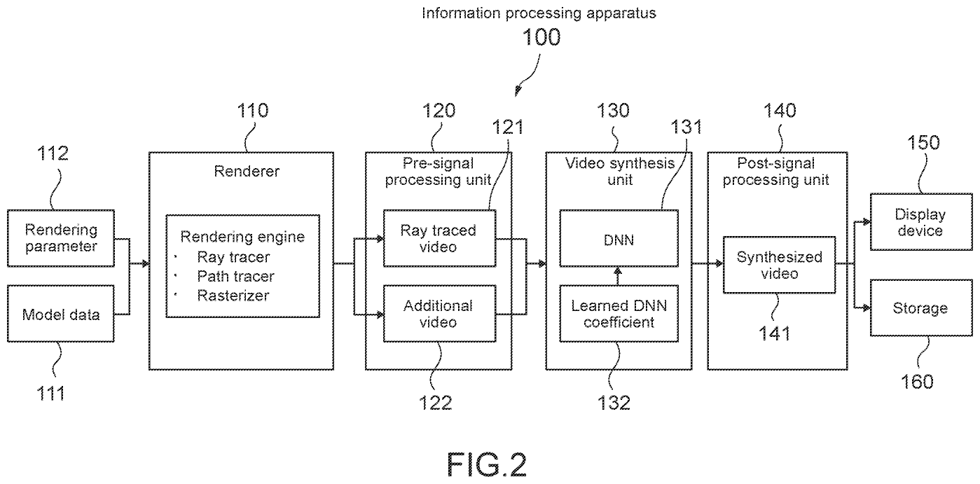

FIG. 2 shows a configuration of the information processing apparatus.

A processor such as a CPU or GPU loads an information processing program, which is recorded on a ROM, to a RAM and executes the information processing program, so that the information processing apparatus 100 operates as a renderer 110, a pre-signal processing unit 120, a video synthesis unit 130, and a post-signal processing unit 140.

The renderer 110 includes a rendering engine (ray tracer or path tracer) of a ray tracing method and a rendering engine (e.g., rasterizer) of a non-ray tracing method.

The video synthesis unit 130 includes a deep neural network (DNN) 131 and a learned DNN coefficient 132. The DNN 131 performs synthesis (fusion) processing on the ray traced video and the additional video rendered by the non-ray tracing method to create a synthesized video. If there is another additional video of internal components or the like, the DNN 131 synthesizes that additional video as well. The learned DNN coefficient 132 is created by learning, for example, with two videos of a low-SPP ray traced video and a video rendered by the non-ray tracing method as students and with a high-SPP ray traced video as a teacher. The learned DNN coefficient 132 is learned so as to output a low-noise and high-resolution video corresponding to the ray tracing method on the basis of the input videos of the students and the teacher. Note that the video synthesis unit 130 may create a synthesized video by, though not limited to the DNN, model-based processing such as a guided filter.

The information processing apparatus 100 includes a display device 150 and a storage 160. The display device 150 is a display such as a 3D display. The storage 160 is a large-capacity nonvolatile recording medium such as an HDD or an SSD.

### 3. Operation Flow of Information Processing Apparatus

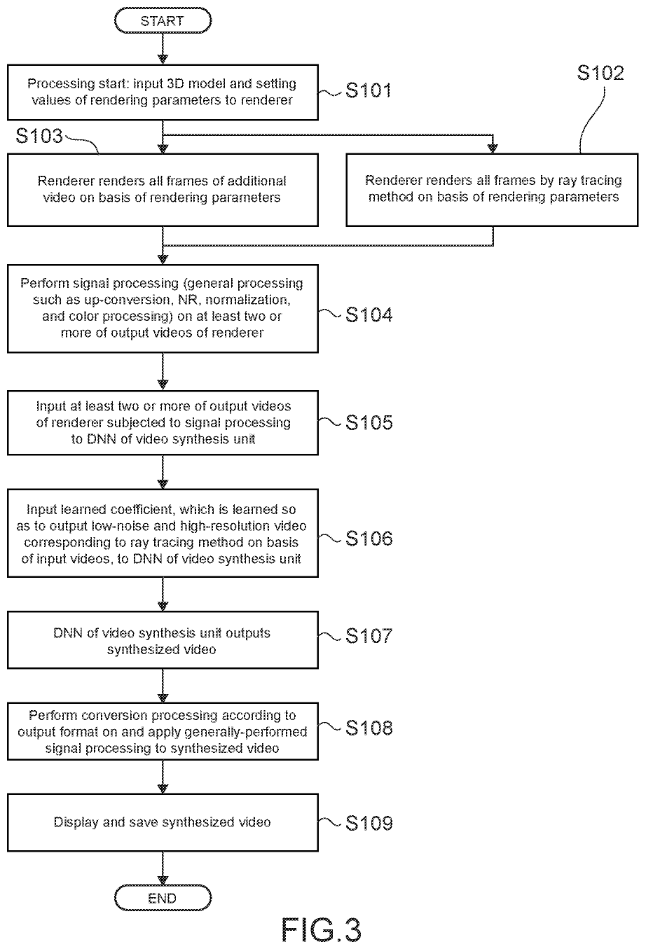

FIG. 3 shows an operation flow of the information processing apparatus.

The information processing apparatus 100 loops the operation flow for each frame.

Model data 111 and rendering parameters 112 are input to the renderer 110 (Step S101). The model data 111 is a general 3D model such as mesh, point cloud, or voxel. The rendering parameters 112 include the setting values of rendering by the ray tracing method (SPP, resolution, etc.) and the setting values of rendering by the non-ray tracing method.

The renderer 110 renders the model data 111 on the basis of the rendering parameters 112 by the ray tracing method to create a ray traced video 121 (Step S102). Here, the renderer 110 renders the model data 111 by the ray tracing method at low SPP and/or low resolution and at high speed as compared with a goal image quality. The low SPP is, for example, 1 SPP or more and less than 16 SPP.

The renderer 110 renders the model data 111 on the basis of the rendering parameters 112 by the non-ray tracing method (e.g., rasterization method) to create an additional video 122 (Step S103).

The pre-signal processing unit 120 performs pre-signal processing on the ray traced video 121 and the additional video 122 (Step S104). The pre-signal processing is general pre-signal processing used for input to the DNN 131. The pre-signal processing includes, for example, up-conversion, noise reduction (NR), normalization, color processing, and anti-aliasing.

The video synthesis unit 130 inputs the ray traced video 121 and the additional video 122, which have been subjected to the pre-signal processing, to the DNN 131 (Step S105). The video synthesis unit 130 inputs the learned DNN coefficient 132 to the DNN 131 (Step S106). Note that the step of inputting the learned DNN coefficient 132 only needs to be performed on the first frame, or may be performed before the operation on the first frame starts. The DNN 131 synthesizes the ray traced video 121 and the additional video 122, which have been subjected to the pre-signal processing, to create a synthesized video 141 (Step S107).

The post-signal processing unit 140 performs post-signal processing on the synthesized video 141 (Step S108). The post-signal processing includes conversion processing according to an output format (i.e., display format and storage format) and general signal processing. The post-signal processing includes up-conversion, NR, color processing, tone mapping, anti-aliasing, compression, and the like.

The post-signal processing unit 140 outputs the synthesized video 141 subjected to the post-signal processing to the display device 150 and the storage 160 (Step S109). The display device 150 displays the synthesized video 141 subjected to the post-signal processing. The storage 160 saves the synthesized video 141 subjected to the post-signal processing.

### II. Second Embodiment

Hereinafter, the same configurations and operations as those already described will be omitted from the description and illustration, and the different configurations and operations will be mainly described.

### 1. Outline of Second Embodiment

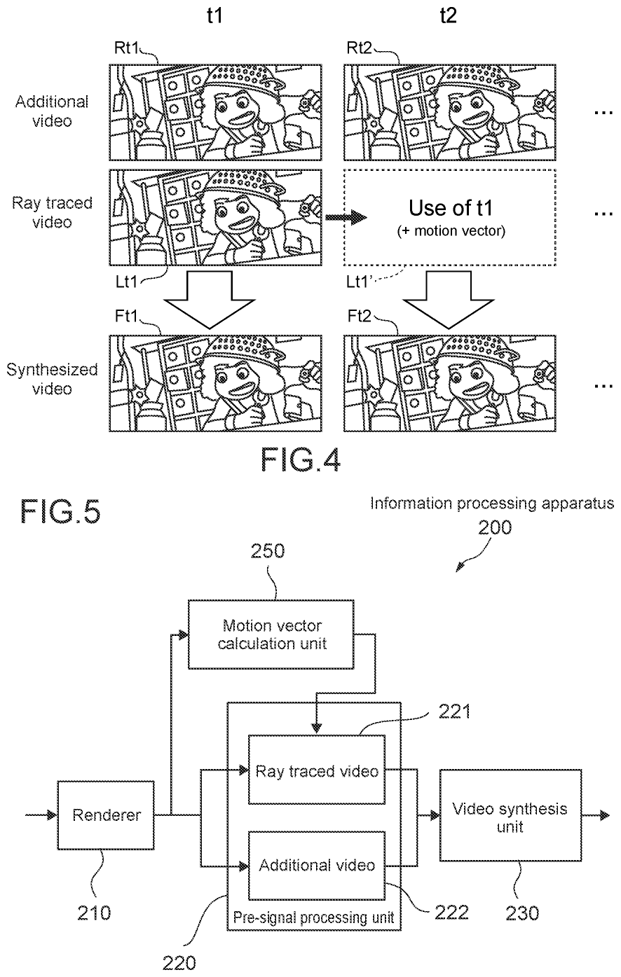

FIG. 4 shows a concept of a second embodiment of the present disclosure.

An information processing apparatus 200 of the second embodiment does not render all frames of model data 111 by the ray tracing method, but renders the model data 111 for every N frames by the ray tracing method, to temporally thin out the model data 111 and create a ray traced video. Meanwhile, the information processing apparatus 200 renders all frames of the model data 111 by the non-ray tracing method, and creates additional videos of all the frames.

For example, the information processing apparatus 200 renders the model data 111 of a frame t1 by the ray tracing method to create a ray traced video Lt1, and renders the model data 111 of the frame t1 by the non-ray tracing method to create an additional video Rt1. The information processing apparatus 200 synthesizes the additional video Rt1 of the frame t1 and the ray traced video Lt1 of the frame t1, to thereby create a synthesized video Ft1 of the frame t1. Meanwhile, the information processing apparatus 200 renders the model data 111 of a frame t2 by the non-ray tracing method to create an additional video Rt2, without performing rendering by the ray tracing method and without creating a ray traced video. The information processing apparatus 200 synthesizes the additional video Rt2 of the frame t2 and a ray traced video Lt1′, which is obtained by correcting the ray traced video Lt1 of the frame t1 for the frame t2, to create a synthesized video Ft2 of the frame t2.

The information processing apparatus 100 of the first embodiment renders all frames of the model data 111 by the ray tracing method and creates ray traced videos. In the first embodiment, when rendering is performed by the ray tracing method at low SPP such as 1 SPP or at low resolution in pursuit of short time processing, the noise in the ray traced video becomes very strong and there is a possibility that noise will remain in a synthesized result.

In view of the circumstances as described above, the information processing apparatus 200 of the second embodiment temporally thins out the model data 111 to create a ray traced video. Since the number of times of rendering by the ray tracing method is reduced, it is possible to take more time for each rendering accordingly and to create a ray traced video at relatively high SPP (e.g., 8 SPP). Consequently, the second embodiment achieves both of high speed and higher image quality.

### 2. Configuration of Information Processing Apparatus

FIG. 5 shows a configuration of the information processing apparatus.

Only a configuration of the information processing apparatus 200 of the second embodiment, which is different from that of the information processing apparatus 100 of the first embodiment (see FIG. 2), will be illustrated.

A processor such as a CPU or GPU loads an information processing program, which is recorded on a ROM, to a RAM and executes the information processing program, so that the information processing apparatus 200 further operates as a motion vector calculation unit 250, in addition to a renderer 210, a pre-signal processing unit 220, a video synthesis unit 230, and the post-signal processing unit 140 (see FIG. 2).

### 3. Operation Flow of Information Processing Apparatus

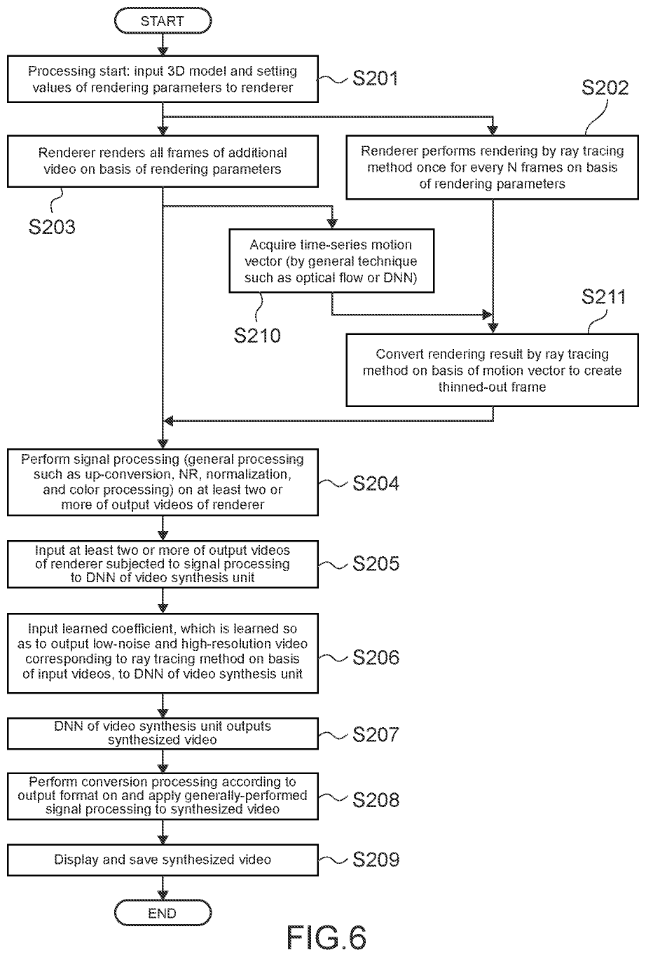

FIG. 6 shows an operation flow of the information processing apparatus.

The information processing apparatus 200 loops the operation flow for each frame.

Model data 111 and rendering parameters 112 are input to the renderer 210 (Step S201).

The renderer 210 renders the model data 111 for every N frames by the ray tracing method on the basis of the rendering parameters 112, to temporally thin out the model data 111 and to create ray traced videos 221 (Step S202). Here, the renderer 210 renders the model data 111 by the ray tracing method at low SPP (e.g., 8 SPP) and/or low resolution and at high speed as compared with a goal image quality.

The renderer 210 renders all frames of the model data 111 on the basis of the rendering parameters 112 by a non-ray tracing method (e.g., rasterization method) to create additional videos 222 (Step S203).

On the basis of an additional video of the N frame and an additional video of a frame N+1 (referred to as thinned-out frame), for which a ray traced video is not created, the motion vector calculation unit 250 calculates a motion vector from the N frame to the thinned-out frame N+1 (Step S210). In the example of FIG. 4, the motion vector calculation unit 250 calculates a motion vector from a frame t1 to a thinned-out frame t2 on the basis of the additional video Rt1 of the frame t1 and the additional video Rt2 of the thinned-out frame t2. For example, the motion vector calculation unit 250 only needs to calculate a motion vector by, for example, calculating an optical flow from the additional video Rt1 of the frame t1 and the additional video Rt2 of the thinned-out frame t2. Alternatively, the motion vector calculation unit 250 only needs to calculate a motion vector from the additional video Rt1 of the frame t1 and the additional video Rt2 of the thinned-out frame t2 by using a motion vector calculation DNN.

The pre-signal processing unit 220 corrects the ray traced video of the N frame on the basis of the motion vector, to create a corrected ray traced video. Specifically, the pre-signal processing unit 220 performs warping processing on the ray traced video of the N frame on the basis of the motion vector to perform shape correction, to create a corrected ray traced video. In the example of FIG. 4, the pre-signal processing unit 220 corrects the ray traced video Lt1 of the frame t1 on the basis of the motion vector, to create a corrected ray traced video Lt1′ (Step S211).

The following Step S204 is the same as Step S104 and subsequent steps of the first embodiment. In the example of FIG. 4, for the thinned-out frame t2, the pre-signal processing unit 220 performs pre-signal processing on the corrected ray traced video Lt1′ and the additional video Rt2 (Step S204). The pre-signal processing is general pre-signal processing for input to the DNN 131. The pre-signal processing includes, for example, up-conversion, noise reduction (NR), normalization, color processing, anti-aliasing. The video synthesis unit 230 inputs the corrected ray traced video Lt1′ and the additional video Rt2, which have been subjected to the pre-signal processing, to the DNN 131 (Step S205). The video synthesis unit 230 inputs the learned DNN coefficient 132 to the DNN 131 (Step S206). The DNN 131 synthesizes the corrected ray traced video Lt1′ and the additional video Rt2, which have been subjected to the pre-signal processing, to create a synthesized video Ft2 (Step S207). The post-signal processing unit 140 performs post-signal processing on the synthesized video Ft2 (Step S208) and outputs the resultant synthesized video Ft2 (Step S209).

As described above, the information processing apparatus 200 of the second embodiment temporally thins out the model data 111 to create a ray traced video. Since the number of times of rendering by the non-ray tracing method is reduced, it is possible to take more time for each rendering accordingly and to create a ray traced video at relatively high SPP (e.g., 8 SPP). Further, as the ray traced video used for the thinned-out frame, a ray traced video, which is corrected on the basis of a motion vector calculated from a plurality of additional videos having been rendered, is used. This makes it possible to create a temporally smooth synthesized video without creating ray traced videos of all frames. Consequently, the second embodiment achieves both of high speed and higher image quality.

### III. Third Embodiment

### 1. Outline of Third Embodiment

An embodiment concept of the third embodiment is the same as the concept of the second embodiment. Note that the processing of creating a corrected ray traced video is different. In the second embodiment, the pre-signal processing unit 120 corrects the ray traced video of the N frame on the basis of the motion vector to create a corrected ray traced video. In contrast to this, in the third embodiment, when creating a synthesized video by using the DNN 131, a video synthesis unit 130 uses the DNN 131 to correct the ray traced video of the N frame on the basis of the motion vector, to thereby create a corrected ray traced video.

### 2. Configuration of Information Processing Apparatus

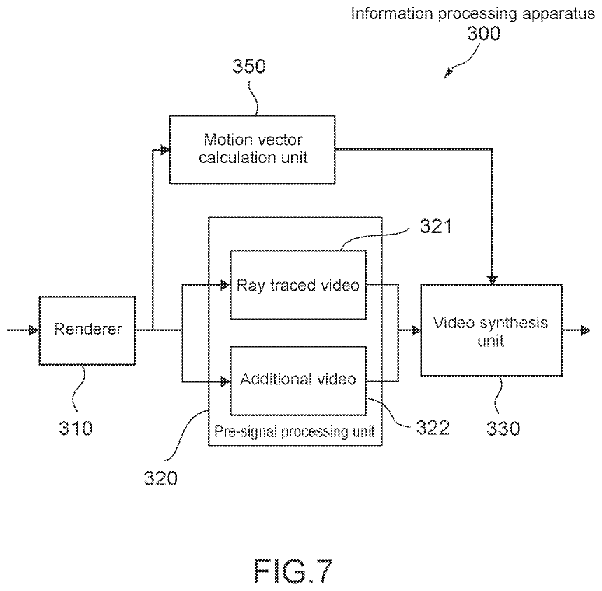

FIG. 7 shows a configuration of an information processing apparatus of the third embodiment of the present disclosure.

The blocks of an information processing apparatus 300 of the third embodiment are the same as the blocks of the information processing apparatus 200 of the second embodiment, but an output destination of a motion vector calculation unit 350 is different.

### 3. Operation Flow of Information Processing Apparatus

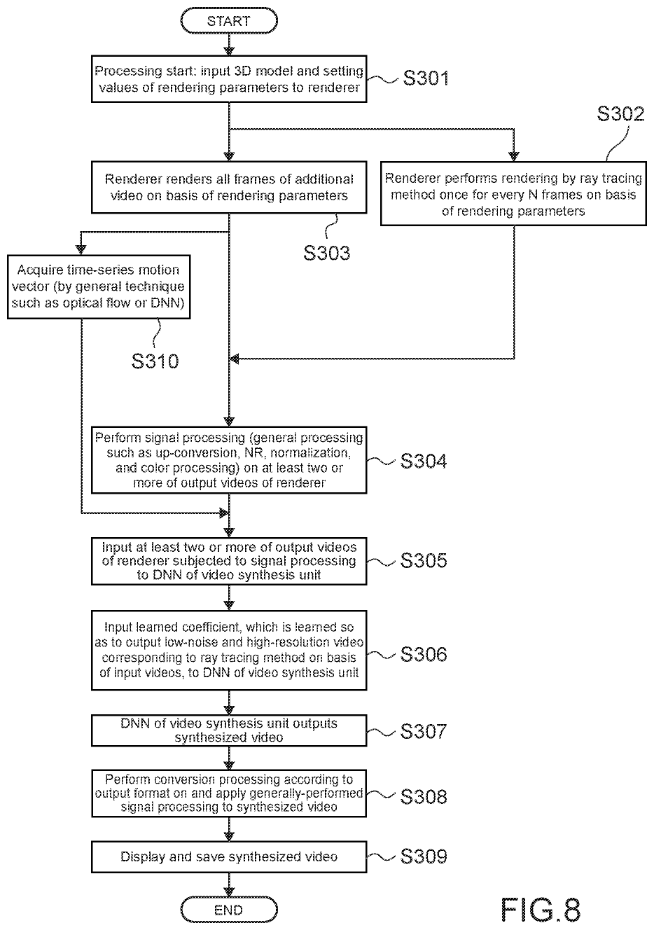

FIG. 8 shows an operation flow of the information processing apparatus.

The information processing apparatus 300 loops the operation flow for each frame.

Model data 111 and rendering parameters 112 are input to a renderer 310 (Step S301).

The renderer 310 renders the model data 111 for every N frames by the ray tracing method on the basis of the rendering parameters 112, to temporally thin out the model data 111 and to create ray traced videos 321 (Step S302). Here, the renderer 310 renders the model data 111 by the ray tracing method at low SPP (e.g., 8 SPP) and/or low resolution and at high speed as compared with a goal image quality.

The renderer 310 renders all frames of the model data 111 on the basis of the rendering parameters 112 by a non-ray tracing method (e.g., rasterization method) to create additional videos 322 (Step S303).

On the basis of an additional video of the N frame and an additional video of a frame N+1 (referred to as thinned-out frame), for which a ray traced video is not created, the motion vector calculation unit 350 calculates a motion vector from the N frame to the thinned-out frame N+1 (Step S310). In the example of FIG. 4, the motion vector calculation unit 350 calculates a motion vector from a frame t1 to a thinned-out frame t2 on the basis of the additional video Rt1 of the frame t1 and the additional video Rt2 of the thinned-out frame t2. The processing so far is the same as that of the second embodiment.

The pre-signal processing unit 320 performs pre-signal processing on the ray traced video 321 and the additional video 322 (Step S304). In the example of FIG. 4, for the frame t1, the pre-signal processing unit 320 performs pre-signal processing on the ray traced video Lt1 and the additional video Rt1, and for the thinned-out frame t2, performs pre-signal processing on the additional video Rt2. The pre-signal processing is general pre-signal processing for input to the DNN 131. The pre-signal processing includes, for example, up-conversion, noise reduction (NR), normalization, color processing, anti-aliasing.

For the thinned-out frame t2, the video synthesis unit 330 inputs the ray traced video Lt1 and the additional video Rt2, which have been subjected to the pre-signal processing, and the motion vector to the DNN 131 (Step S305).

The video synthesis unit 330 inputs a learned DNN coefficient 132 to the DNN 131 (Step S306). The learned DNN coefficient 132 has been obtained by learning warping processing based on the motion vector.

The DNN 131 synthesizes the ray traced video Lt1 and the additional video Rt2, which have been subjected to the pre-signal processing, and the motion vector, to create a synthesized video Ft2 (Step S307). Specifically, the DNN 131 performs warping processing on the ray traced video Lt1 on the basis of the motion vector to perform shape correction, to create a corrected ray traced video Lt1′, and at the same time, synthesizes the corrected ray traced video Lt1′ and the additional video Rt2 to create a synthesized video Ft2.

The post-signal processing unit 140 performs post-signal processing on the synthesized video Ft2 (Step S308) and outputs the resultant synthesized video Ft2 (Step S309).

The third embodiment also provides the same effects as those in the second embodiment.

As a modified example of the third embodiment, the information processing apparatus 300 may include no motion vector calculation unit 350, and the DNN 131 of the video synthesis unit 330 may calculate a motion vector instead of the motion vector calculation unit 350. In this case, the learned DNN coefficient 132 has been obtained by learning the calculation processing of a motion vector. For the thinned-out frame t2, the ray traced video Lt1 and the additional video Rt1 of the frame t1 and the additional video Rt2 of the thinned-out frame t2 are input to the DNN 131. The DNN 131 calculates a motion vector on the basis of the additional video Rt1 of the frame t1 and the additional video Rt2 of the thinned-out frame t2, and corrects the ray traced video Lt1 of the frame t1 on the basis of the motion vector to create a ray traced video Lt1′, and synthesizes the corrected ray traced video Lt1′ and the additional video Rt2 to create a synthesized video Ft2.

### IV. Fourth Embodiment

### 1. Outline of Fourth Embodiment

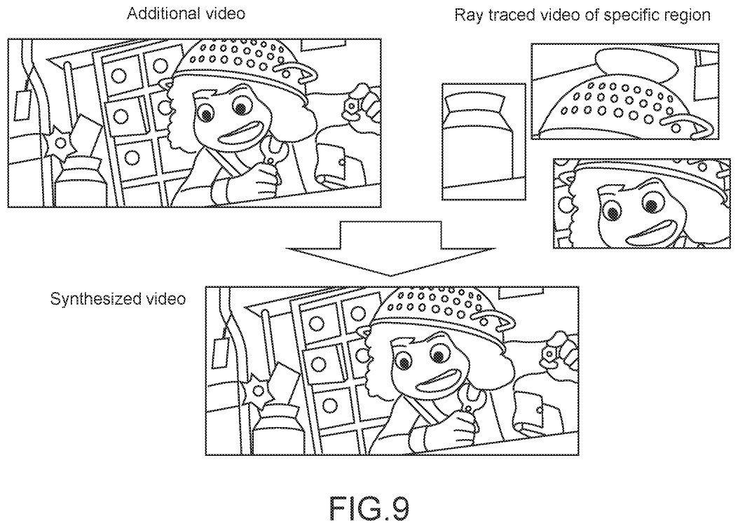

FIG. 9 shows a concept of a fourth embodiment of the present disclosure.

An information processing apparatus 400 of the fourth embodiment renders a part of the region of model data 411 by the ray tracing method, without rendering the entire region of the model data 411 by the ray tracing method, and limits a rendering target in a representation region unique to the ray tracing method of the model data (in other words, spatially thins out a region to be rendered) to create a ray traced video. Meanwhile, the information processing apparatus 400 renders the entire region of the model data 411 by the non-ray tracing method and creates an additional video of the entire region.

As described above, the ray tracing method can provide light source component representations such as a direct reflected light representation, an indirect reflected light representation, a transmitted light representation, an internally diffused light representation, and a self-luminance representation, scattering representations such as clouds and fog, and hair rendering representations such as hair and fur. On the other hand, the non-ray tracing method is incapable of providing light source component representations, scattering representations, hair rendering representations, and the like.

In this regard, in the fourth embodiment, only a region necessary to be represented realistically, that is, a representation region unique to the ray tracing method such as light source component representations (hereinafter, also referred to as representation region) is rendered by the ray tracing method. In other words, in the fourth embodiment, only a region incapable of being represented by the non-ray tracing method is rendered by the ray tracing method. Meanwhile, regions other than the representation region (i.e., region such as a background without having light source components, hair, etc.) can be rendered with sufficiently high image quality by the non-ray tracing method. Thus, the regions other than the representation region are merely rendered by the non-ray tracing method. In the fourth embodiment, the ray traced video of only the representation region is synthesized with the additional video of the entire region, to create a synthesized video.

The information processing apparatus 400 of the fourth embodiment limits a rendering target to the representation region unique to the ray tracing method of the model data 411 (in other words, spatially thins out a region to be rendered) to create a ray traced video of only the representation region unique to the ray tracing method. Since the region to be rendered by the ray tracing method is reduced, it is possible to take more time for rendering the representation region accordingly and to create a ray traced video of the representation region at high SPP (e.g., 128 SPP). Consequently, the fourth embodiment achieves both of high speed and higher image quality. Note that a temporal thinning-out technique (second and third embodiments) and a spatial thinning-out technique (fourth and fifth embodiments) are compatible.

### 2. Configuration of Information Processing Apparatus

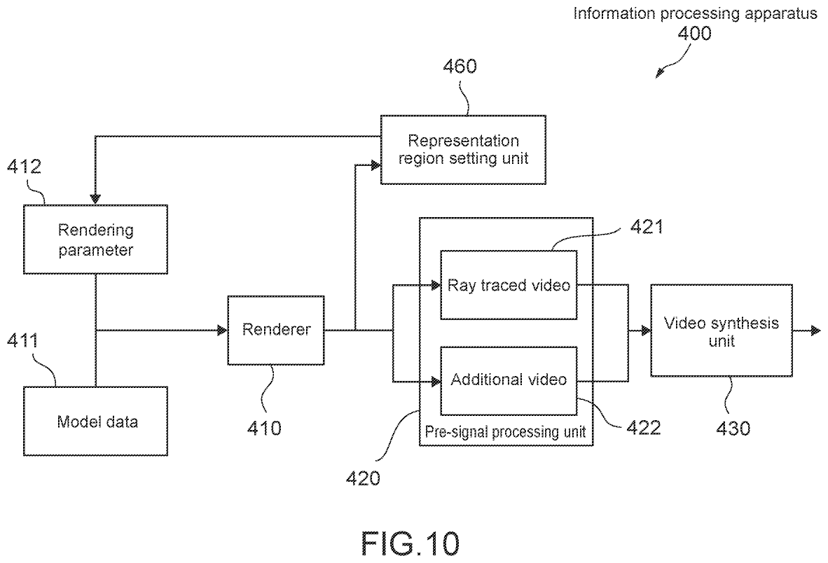

FIG. 10 shows a configuration of the information processing apparatus.

Only a configuration of the information processing apparatus 400 of the fourth embodiment, which is different from that of the information processing apparatus 100 of the first embodiment (see FIG. 2), will be illustrated.

A processor such as a CPU or GPU loads an information processing program, which is recorded on a ROM, to a RAM and executes the information processing program, so that the information processing apparatus 400 further operates as a representation region setting unit 460, in addition to a renderer 410, a pre-signal processing unit 420, a video synthesis unit 430, and the post-signal processing unit 140 (see FIG. 2).

### 3. Operation Flow of Information Processing Apparatus

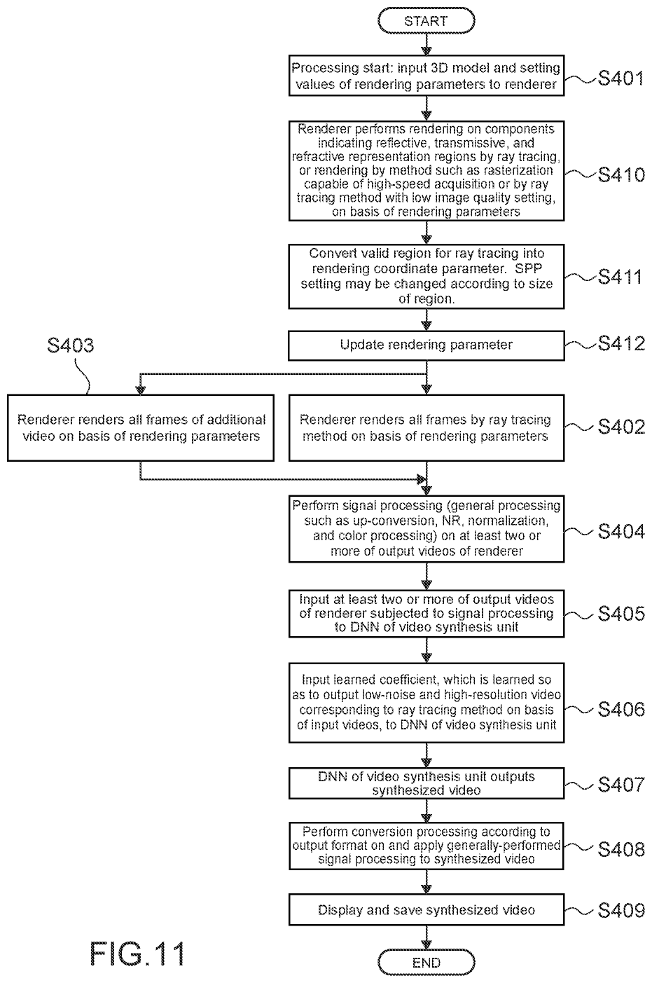

FIG. 11 shows an operation flow of the information processing apparatus.

The information processing apparatus 400 loops the operation flow for each frame.

Model data 411 and rendering parameters 412 are input to the renderer 410 (Step S401).

The renderer 410 creates a mask video from the model data 411 (Step S410). The mask video is a video in which a representation region unique to the ray tracing method is masked in the entire region of one frame.

As an example, the renderer 410 creates a mask video for masking the representation region on the basis of the material setting of the model data 411. For example, the renderer 410 masks a specular region, a refractive region, and a transmissive region on the basis of the material setting of optical components (reflectance, setting of bidirectional reflectance distribution function (BRDF) of surface, etc.), and creates a mask video for masking a hair region, a volume region (smoke, water, etc.) on the basis of the material setting of materials.

As another example, the renderer 410 pre-renders the model data 411 at high speed by a non-ray tracing method (rasterization or the like) or a ray tracing method at low SPP and/or low resolution to create a pre-rendered video and then create a mask video for masking a representation region on the basis of the internal components of the pre-rendered video. For example, the renderer 410 pre-renders the model data 411 at high speed at 1 SPP to create a pre-rendered video. The renderer 410 creates a mask video for masking a representation region (specular reflection, hair region, volume region, etc.) including a specific AOVs component on the basis of the AOVs components of the pre-rendered video. The AOVs components are internal components constituting a video of a ray tracing method and are divided into subject components such as diffuse, direct, and volume, and for each of the components, light-receiving components such as direct, indirect, and object color. Note that the AOVs components of 1 SPP contain noise, and thus expansion processing or binarization processing may be applied after denoising.

The representation region setting unit 460 sets a representation region specified by the mask video created by the renderer 410. Specifically, the representation region setting unit 460 converts the representation region, which is specified by the mask video created by the renderer 410, into a rendering coordinate parameter. In addition, the representation region setting unit 460 sets a rendering parameter (that is, SPP or resolution of the representation region) used when the representation region is rendered by the ray tracing method (Step S411).

For example, the representation region setting unit 460 sets the rendering parameter on the basis of the ratio of the representation region to the entire region of the ray traced video. In other words, the representation region setting unit 460 sets the rendering parameter on the basis of the size of the representation region. Specifically, the representation region setting unit 460 only needs to set the rendering parameter (that is, SPP of the representation region) on the basis of the ratio of the representation region, using the expression “SPP of the representation region=SPP of the synthesized image as a goal x (the number of pixels of the entire region/the number of pixels of the representation region)”. This makes it possible to render the ray traced video to have the highest image quality in a suitable speed range on the basis of the ratio of the representation region. Note that, in the case of moving images, the representation regions of all frames may be calculated in advance and then the rendering processing may be executed.

The representation region setting unit 460 updates a rendering parameter 412 by using the set rendering coordinate parameter and rendering parameter (SPP, resolution) (Step S412).

The renderer 410 renders only the representation region of the model data 411 by the ray tracing method on the basis of the updated rendering parameter 412 to create a ray traced video 421 (Step S402).

The renderer 410 renders the entire region of the model data 411 by the non-ray tracing method (e.g., rasterization method) on the basis of the rendering parameter 412 to create an additional video 422 (Step S403).

The pre-signal processing unit 420 performs pre-signal processing on the ray traced video 421 of the representation region and the additional video 422 of the entire region (Step S404).

The video synthesis unit 430 inputs the ray traced video 421 of the representation region and the additional video 422 of the entire region, which have been subjected to the pre-signal processing, to the DNN 131 (Step S405). The video synthesis unit 430 inputs the learned DNN coefficient 132 to the DNN 131 (Step S406). The DNN 131 synthesizes the ray traced video 421 of the representation region and the additional video 422 of the entire region, which have been subjected to the pre-signal processing, and creates a synthesized video 441 (Step S407).

The post-signal processing unit 140 performs post-signal processing on the synthesized video 441 (Step S408) and outputs the resultant synthesized video (Step S409).

In such a manner, the information processing apparatus 400 of the fourth embodiment limits a rendering target to a representation region unique to the ray tracing method of the model data 111 (in other words, spatially thins out a region to be rendered) to create a ray traced video of only the representation region unique to the ray tracing method. Since the region to be rendered by the ray tracing method is reduced, it is possible to take more time for rendering the representation region accordingly and to create a ray traced video of the representation region at high SPP (e.g., 128 SPP). This makes it possible to achieve both of high speed and higher image quality in the fourth embodiment.

### V. Fifth Embodiment

### 1. Outline of Fifth Embodiment

The embodiment concept of the fifth embodiment is the same as the concept of the fourth embodiment. Note that the following points are different. In the fourth embodiment, the renderer 410 creates a mask video for masking a representation region. In this method, the renderer 410 creates a mask video for masking a representation region according to the system rules of the renderer 410. Meanwhile, if processing is performed as an external application programming interface (API), it may be impossible to operate the inside of the renderer 410. In this regard, in the fifth embodiment, a representation region is specified outside of the renderer.

### 2. Configuration of Information Processing Apparatus

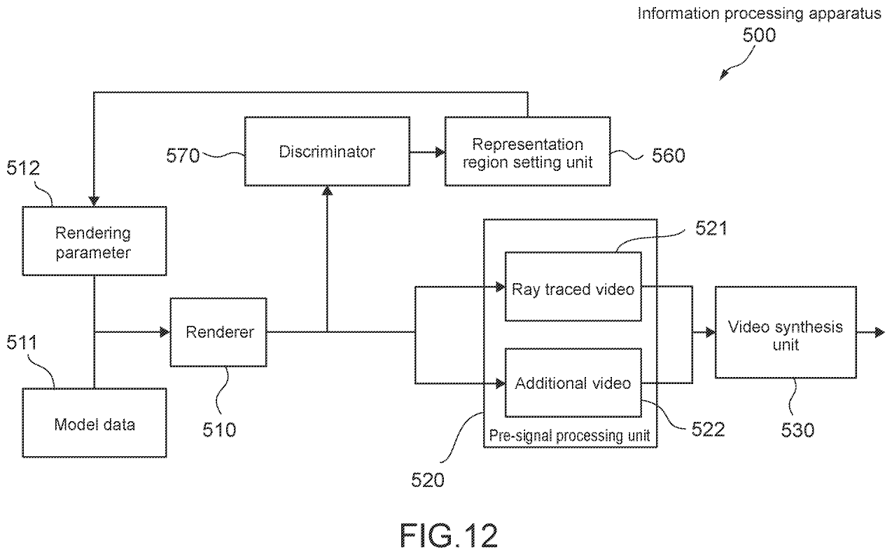

FIG. 12 shows a configuration of an information processing apparatus of the fifth embodiment of the present disclosure.

Only a configuration of an information processing apparatus 500 of the fifth embodiment, which is different from that of the information processing apparatus 100 of the first embodiment (see FIG. 2), will be illustrated.

A processor such as a CPU or GPU loads an information processing program, which is recorded on a ROM, to a RAM and executes the information processing program, so that the information processing apparatus 500 further operates as a discriminator 570 and a representation region setting unit 560, in addition to a renderer 510, a pre-signal processing unit 520, a video synthesis unit 530, and the post-signal processing unit 140 (see FIG. 2).

### 3. Operation Flow of Information Processing Apparatus

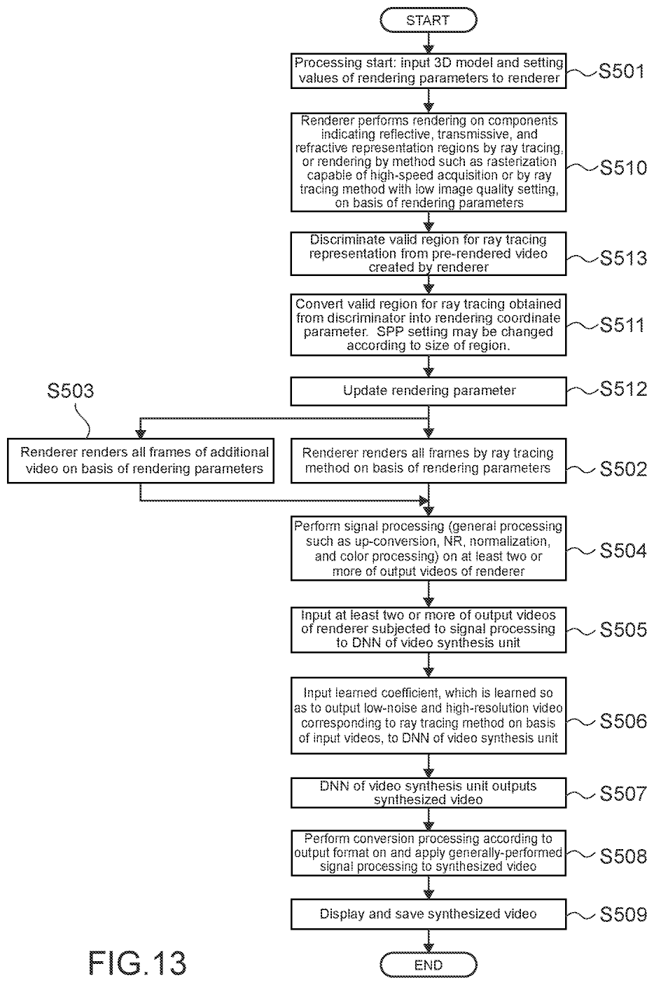

FIG. 13 shows an operation flow of the information processing apparatus.

The information processing apparatus 400 loops the operation flow for each frame.

Model data 511 and rendering parameters 512 are input to the renderer 510 (Step S501).

The renderer 510 pre-renders the model data 511 to create a pre-rendered video (Step S510). Specifically, the renderer 510 pre-renders the model data 511 at high speed by a non-ray tracing method (rasterization or the like) or a ray tracing method at low SPP and/or low resolution, to create a pre-rendered video.

The discriminator 570 discriminates a representation region from the pre-rendered video created by the renderer 510 (Step S513). For example, the discriminator 570 predicts a representation region of a material label (specular reflection, transmission, hair, volume) from the pre-rendered video (e.g., rasterized video) by using semantic segmentation.

The representation region setting unit 560 sets the representation region discriminated by the discriminator 570. Specifically, the representation region setting unit 560 converts the representation region discriminated by the discriminator 570 into a rendering coordinate parameter. In addition, the representation region setting unit 560 sets a rendering parameter (that is, SPP or resolution of the representation region) used when the representation region is rendered by the ray tracing method (Step S511).

The representation region setting unit 560 updates a rendering parameter 512 by using the set rendering coordinate parameter and rendering parameter (SPP, resolution) (Step S512).

The processing subsequent to Step S502 is the same as in the fourth embodiment.

The fifth embodiment also provides the same effects as those in the fourth embodiment.

### VI. Conclusion

In Non-Patent Literature 1, a ray traced video rendered at high speed by a ray tracing method set at low SPP (e.g., 16 SPP), an Albedo component, and a normal map are synthesized using the DNN. In short, Non-Patent Literature 1 merely creates a ray traced video as a video for viewing, and corrects the ray traced video on the basis of the Albedo component and the normal map. Thus, in Non-Patent Literature 1, if a ray traced video with extremely low SPP (e.g., 1 SPP) is created, there is a possibility that a ray traced video as a goal does not have a sufficiently high image quality. For this reason, in Non-Patent Literature 1, 16 SPP is assumed to be used, though it is low SPP. Further, since Non-Patent Literature 1 merely creates a ray traced video as a video for viewing, it is not possible to render the ray traced video by temporally and spatially thinning out the ray traced video.

In contrast, according to each embodiment of the present disclosure, the information processing apparatus creates, as a video for viewing, a ray traced video capable of light source component representations or the like, and a video incapable of light source component representations or the like but having high image quality (additional video). Since the ray traced video and the additional video are synthesized, there is no problem even if the SPP of the ray traced video is greatly reduced to approximately 1 SPP, because the image quality is ensured by the additional video. This makes it possible to greatly reduce the SPP of the ray traced video to approximately 1 SPP and increase the processing speed. Further, the information processing apparatus can create a synthesized video, which makes use of the advantages of both the ray traced video and the additional video and compensates for the disadvantages thereof, at high speed. Further, since the ray traced videos of all frames and the entire region are created, it is possible to perform rendering by temporally and spatially thinning out the ray traced video. Since the number of times of rendering and the region therefor by the ray tracing method are reduced, it is possible to take more time for rendering accordingly and to create a ray traced video of the part necessary in time and space at relatively high SPP. This makes it possible to achieve both of high speed and higher image quality in each embodiment.

The present disclosure may have the following configurations.

(1) An information processing apparatus, including:
a renderer that
   renders model data by a ray tracing method and creates a ray traced video, and
   renders the model data by a method different from the ray tracing method and creates an additional video; and
a video synthesis unit that synthesizes the additional video and the ray traced video and creates a synthesized video.

(2) The information processing apparatus according to (1), in which
the renderer renders the model data for every N frames by the ray tracing method, temporally thins out the model data, and creates the ray traced video,
the information processing apparatus further includes a motion vector calculation unit that calculates a motion vector from the N frame to a thinned-out frame on the basis of an additional video of the N frame and an additional video of the thinned-out frame, the thinned-out frame being a frame for which a ray traced video is not created, and
the video synthesis unit synthesizes the additional video of the thinned-out frame and a corrected ray traced video created by correcting the ray traced video of the N frame on the basis of the motion vector, and creates a synthesized video of the thinned-out frame.

(3) The information processing apparatus according to (2), further including
a pre-signal processing unit that creates the corrected ray traced video.

(4) The information processing apparatus according to (2), in which
the video synthesis unit creates the corrected ray traced video.

(5) The information processing apparatus according to any one of (1) to (4), further including
a representation region setting unit that sets a representation region unique to the ray tracing method of the model data, in which
the renderer renders the representation region of the model data by the ray tracing method and creates the ray traced video, and
the video synthesis unit synthesizes the additional video and the ray traced video of the representation region and creates a synthesized video.

(6) The information processing apparatus according to (5), in which
the renderer creates a mask video for masking the representation region on the basis of a material setting of the model data, and
the representation region setting unit sets the representation region specified by the mask video.

(7) The information processing apparatus according to (5), in which
the renderer
   pre-renders the model data by a ray tracing method of lower samples per pixel (SPP) and/or lower resolution than that of the ray tracing method and creates a pre-rendered video, and
   creates a mask video for masking the representation region on the basis of an internal component of the pre-rendered video, and
the representation region setting unit sets the representation region specified by the mask video.

(8) The information processing apparatus according to (5), in which
the renderer pre-renders the model data by a ray tracing method of lower samples per pixel (SPP) and/or lower resolution than that of the ray tracing method and creates a pre-rendered video,
the information processing apparatus further includes a discriminator that discriminates the representation region from the pre-rendered video created by the renderer, and
the representation region setting unit sets the representation region predicted from the pre-rendered video.

(9) The information processing apparatus according to any one of (5) to (8), in which
the representation region setting unit sets a rendering parameter used when the representation region is rendered by the ray tracing method, and
the renderer renders the representation region of the model data by the ray tracing method on the basis of the rendering parameter and creates the ray traced video.

(10) The information processing apparatus according to (9), in which
the representation region setting unit sets the rendering parameter on the basis of a ratio of the representation region to an entire region of the ray traced video.

(11) The information processing apparatus according to any one of (1) to (10), in which
the renderer renders the model data by a non-ray tracing method or a ray tracing method of lower samples per pixel (SPP) and/or lower resolution than that of the ray tracing method, as a method different from the ray tracing method, and creates the additional video.

(12) The information processing apparatus according to (11), in which
the non-ray tracing method is a rasterization method, a Z-sorting method, a Z-buffer method, or a scanline method.

(13) The information processing apparatus according to any one of (1) to (12), in which
the renderer further creates, as the additional video, an internal component including an Albedo component, a normal component, a depth component, a roughness component, a UV map component, an arbitrary output variables (AOVs) component, and/or a shadow map component of the additional video.

(14) The information processing apparatus according to any one of (1) to (13), in which
the ray tracing method is ray tracing or path tracing.

(15) The information processing apparatus according to any one of (1) to (14), in which
the renderer renders the model data by a ray tracing method of SPP less than 16 SPP and creates the ray traced video.

(16) An information processing method, including:
rendering model data by a ray tracing method and creating a ray traced video;
rendering the model data by a method different from the ray tracing method and creating an additional video; and
synthesizing the additional video and the ray traced video and creating a synthesized video.

(17) An information processing program, which causes a processor of an information processing apparatus to operate to:
render model data by a ray tracing method and create a ray traced video;
render the model data by a method different from the ray tracing method and create an additional video; and
synthesize the additional video and the ray traced video and create a synthesized video.

(18) A non-transitory computer-readable recording medium, which records an information processing program that causes a processor of an information processing apparatus to operate to:
render model data by a ray tracing method and create a ray traced video;
render the model data by a method different from the ray tracing method and create an additional video; and
synthesize the additional video and the ray traced video and create a synthesized video.

The embodiments and modified examples of the present technology have been described above, but the present technology is not limited to the embodiments described above and can be variously modified without departing from the gist of the present technology.

### REFERENCE SIGNS LIST

100, 200, 300, 400, 500 information processing apparatus
110, 210, 310, 410, 510 renderer
111, 411, 511 model data
112, 412, 512 rendering parameter
120, 220, 320, 420, 520 pre-signal processing unit
121, 221, 321, 421 ray traced video
122, 222, 322, 422 additional video
130, 230, 330, 430, 530 video synthesis unit
131 DNN
132 learned DNN coefficient
140 post-signal processing unit
141, 441 synthesized video
150 display device
160 storage
250, 350 motion vector calculation unit
460, 560 representation region setting unit
570 discriminator

1. An information processing apparatus, comprising:
a renderer that
renders model data by a ray tracing method and creates a ray traced video, and
renders the model data by a method different from the ray tracing method and creates an additional video; and
a video synthesis unit that synthesizes the additional video and the ray traced video and creates a synthesized video.

2. The information processing apparatus according to claim 1, wherein
the renderer renders the model data for every N frames by the ray tracing method, temporally thins out the model data, and creates the ray traced video,
the information processing apparatus further comprises a motion vector calculation unit that calculates a motion vector from the N frame to a thinned-out frame on a basis of an additional video of the N frame and an additional video of the thinned-out frame, the thinned-out frame being a frame for which a ray traced video is not created, and
the video synthesis unit synthesizes the additional video of the thinned-out frame and a corrected ray traced video created by correcting the ray traced video of the N frame on a basis of the motion vector, and creates a synthesized video of the thinned-out frame.

3. The information processing apparatus according to claim 2, further comprising
a pre-signal processing unit that creates the corrected ray traced video.

4. The information processing apparatus according to claim 2, wherein
the video synthesis unit creates the corrected ray traced video.

5. The information processing apparatus according to claim 1, further comprising
a representation region setting unit that sets a representation region unique to the ray tracing method of the model data, wherein
the renderer renders the representation region of the model data by the ray tracing method and creates the ray traced video, and
the video synthesis unit synthesizes the additional video and the ray traced video of the representation region and creates a synthesized video.

6. The information processing apparatus according to claim 5, wherein
the renderer creates a mask video for masking the representation region on a basis of a material setting of the model data, and
the representation region setting unit sets the representation region specified by the mask video.

7. The information processing apparatus according to claim 5, wherein
the renderer
pre-renders the model data by a ray tracing method of lower samples per pixel (SPP) and/or lower resolution than that of the ray tracing method and creates a pre-rendered video, and
creates a mask video for masking the representation region on a basis of an internal component of the pre-rendered video, and
the representation region setting unit sets the representation region specified by the mask video.

8. The information processing apparatus according to claim 5, wherein
the renderer pre-renders the model data by a ray tracing method of lower samples per pixel (SPP) and/or lower resolution than that of the ray tracing method and creates a pre-rendered video,
the information processing apparatus further comprises a discriminator that discriminates the representation region from the pre-rendered video created by the renderer, and
the representation region setting unit sets the representation region predicted from the pre-rendered video.

9. The information processing apparatus according to claim 5, wherein
the representation region setting unit sets a rendering parameter used when the representation region is rendered by the ray tracing method, and
the renderer renders the representation region of the model data by the ray tracing method on a basis of the rendering parameter and creates the ray traced video.

10. The information processing apparatus according to claim 9, wherein
the representation region setting unit sets the rendering parameter on a basis of a ratio of the representation region to an entire region of the ray traced video.

11. The information processing apparatus according to claim 1, wherein
the renderer renders the model data by a non-ray tracing method or a ray tracing method of lower samples per pixel (SPP) and/or lower resolution than that of the ray tracing method, as a method different from the ray tracing method, and creates the additional video.

12. The information processing apparatus according to claim 11, wherein
the non-ray tracing method is a rasterization method, a Z-sorting method, a Z-buffer method, or a scanline method.

13. The information processing apparatus according to claim 1, wherein
the renderer further creates, as the additional video, an internal component including an Albedo component, a normal component, a depth component, a roughness component, a UV map component, an arbitrary output variables (AOVs) component, and/or a shadow map component of the additional video.

14. The information processing apparatus according to claim 1, wherein
the ray tracing method is ray tracing or path tracing.

15. The information processing apparatus according to claim 1, wherein
the renderer renders the model data by a ray tracing method of SPP less than 16 SPP and creates the ray traced video.

16. An information processing method, comprising:
rendering model data by a ray tracing method and creating a ray traced video;
rendering the model data by a method different from the ray tracing method and creating an additional video; and
synthesizing the additional video and the ray traced video and creating a synthesized video.

17. An information processing program, which causes a processor of an information processing apparatus to operate to:
render model data by a ray tracing method and create a ray traced video;
render the model data by a method different from the ray tracing method and create an additional video; and
synthesize the additional video and the ray traced video and create a synthesized video.
